(19) United States
(12) Patent Application Publication
(10) Pub. No.: US 2011/0291886 A1
(43) Pub. Date: Dec. 1, 2011

(54) METHOD FOR MARKING LOCATIONS OF ASSOCIATED PERIPHERAL DEVICES

(76) Inventor: MARCUS KRIETER, Newport Beach, CA (US)

(21) Appl. No.: 12/787,761

(22) Filed: May 26, 2010

(51) Int. Cl. G01S 19/12; G01S 19/14

(52) U.S. Cl. 342/357.49; 342/357.52

(57) ABSTRACT

A system and method for marking the location of a lost device using geographical location-sensing means is provided. The method involves time-stamping the moment of disconnection, recording the navigation from point of disconnection, fixing the geographical location, and then applying geographical displacement to GPS coordinates to fix the location of the lost or misplaced device.

### FIELD OF THE INVENTION

The present invention relates to method for locating lost or misplaced devices, and more particularly, to a method and system for locating a separation point of a lost device.

### BACKGROUND

Wireless communication is the transfer of information over a distance without the use of electrical conductors or wires.

Currently known wireless data communication systems operate using the Bluetooth communication protocol. The Bluetooth communication protocol provides for a wireless data communication link between a master device and a plurality of slave devices within a piconet comprising an area within a range of approximately 10 meters (approximately 33 feet) from the master device.

Since the advent of Bluetooth technology in 1994, it has found been increasingly utilized in a large number of applications and environments. Bluetooth is a technology used in transmitting information by providing wireless connectivity between various devices such as mobile phones, printers, GPS receivers, digital cameras, video games, laptops, personal computers, and other electronic devices.

One of the earliest applications that utilized Bluetooth is the wireless control and communication between a mobile phone and a hands-free headset. Currently more and more mobile phones are equipped with Bluetooth functionality and this technology has become a common feature for wireless mobile phone headsets.

Bluetooth headset devices have provided an immense use in communication industry. However, one problem associated with these devices is that due to their small size, users often misplace the Bluetooth device, and it is sometimes difficult for the devices to be found.

As such, there is a need for a method to locate the position of such devices. A method of locating items using a mobile telecommunication device having short range, piconet telecommunication and long range telecommunication ability is disclosed in US Patent application 20030008659 [Waters et al]. The method utilizes a plurality of piconet devices capable of forming a short range piconet with each other and creating an activity log, stating the identity of which piconet devices were in communication at a particular point in time. The method of stated in this application is complicated and requires a plurality of piconet devices to be in communication with each other. Furthermore, the method does not provide the exact location of the lost items.

In light of foregoing discussion, a simple method and system is presented that can determine the location of lost peripheral devices. Furthermore, this method can be used for locating the position of a vehicle in a large parking lot, which is often a difficult task and requires a considerable amount of time.

### BRIEF SUMMARY OF THE INVENTION

In view of the foregoing limitations associated with the use of traditional technology, a simple method and a system is presented for locating the position of associated peripheral devices.

Accordingly an object of the present invention is to provide a method for marking the location of lost peripheral devices.

Another object of present invention is to provide a system for locating the position of lost peripheral devices associated with a particular system.

Accordingly in an aspect of the present invention, a method for locating the position of lost peripheral devices is provided. The method comprises of identifying a disconnect event associated with a peripheral device, enabling immediate recording of navigation through dead reckoning means, enabling acquisition of a global location and then applying dead reckoned geographical displacement to the an absolute fix to provide a geographical fix for the point of disconnection.

In another aspect of the present invention, a system for locating a peripheral device is provided. The system includes an interface to sense a connection with the peripheral device, dead reckoning means, geographical positioning system, and a pre-fix application to activate the dead reckoning means and the geographical positioning system on termination of connection.

In another aspect of the present invention, a device to determine the location of peripheral electronic devices, comprising: a short-range wireless connection interface; a GPS interface coupled to a remote GPS system; a location calculation means configured to analyze GPS coordinate information from the GPS system and local geographic displacement information; and a memory to store local geographic displacement information.

In another aspect of the present invention, a method of locating a short-range peripheral device, comprising the steps of: connectively coupling a master device to a slave device using a wireless interface; monitoring, using a sensor on the master device, the connection between the master device and the slave device; recording, at the master device, a location of a disconnection between the master device and the slave device; recording, at the master device, the navigational path of the master device after the disconnection; and calculating, at the master device, a fixed path between an end-point of the navigational path and the location of the disconnection.

In another aspect of the present invention, a method of locating a short-range peripheral device, comprising the steps of: establishing a connection between a master device and a slave device, the master device coupled to a GPS system; determining, using the GPS system, a location of termination of the connection; transmitting, from the GPS system to the master device, the location of termination; storing, on the master device, the location of termination; tracking, by the GPS system, a navigational path of the master device after the termination of the connection; transmitting, from the GPS system to the master device, the navigational path; and computing, using the GPS system and master device, a navigational fix between the location of termination and an end-point of the navigational path.

### BRIEF DESCRIPTION OF THE DRAWINGS

The preferred embodiments of the invention will hereinafter be described in conjunction with the Figures provided herein to further illustrate various non-limiting embodiments of the invention, wherein like designations denote like elements, and in which:

FIG. 1 illustrates a schematic representation of the system components and peripheral device, in accordance with an embodiment of the present invention.

FIG. 2 illustrates the range of a peripheral device, in accordance with an embodiment of the present invention.

FIG. 3 is a block diagram illustrating an exemplary method for locating a peripheral device associated with the system, in accordance with an embodiment of the present invention.

FIG. 4 illustrates a flow diagram of the search process, in accordance with an embodiment of present invention.

FIG. 5 illustrates an exemplary method for using the system for locating peripheral device, in accordance with an embodiment of the present invention.

### DETAILED DESCRIPTION OF EMBODIMENTS

In the following detailed description of embodiments of the invention, numerous specific details are set forth in order to provide a thorough understanding of the embodiment of invention. However, it will be obvious to a person skilled in art that the embodiments of invention may be practiced with or without these specific details. In other instances well known methods, procedures and components have not been described in details so as not to unnecessarily obscure aspects of the embodiments of the invention.

Furthermore, it will be clear that the invention is not limited to these embodiments only. Numerous modification, changes, variation, substitutions and equivalents will be apparent to those skilled in the art without parting from the spirit and scope of the invention.

The present invention provides a system and a method used thereof for locating the position of a lost peripheral device. The system includes an interface to sense the connection with the peripheral device, the dead reckoning means, a geographical positioning system, and a pre-fix application to activate the dead reckoning means and the global positioning system at the point of disconnection. When the system looses connection with the associated peripheral device, the pre-fix traps this disconnect event, marks this separation point, activates the dead reckoning means to record the navigation, enables acquisition of global location and then applies the dead reckoned geographical displacement and global position coordinates to provide a geographical fix for the point of disconnection.

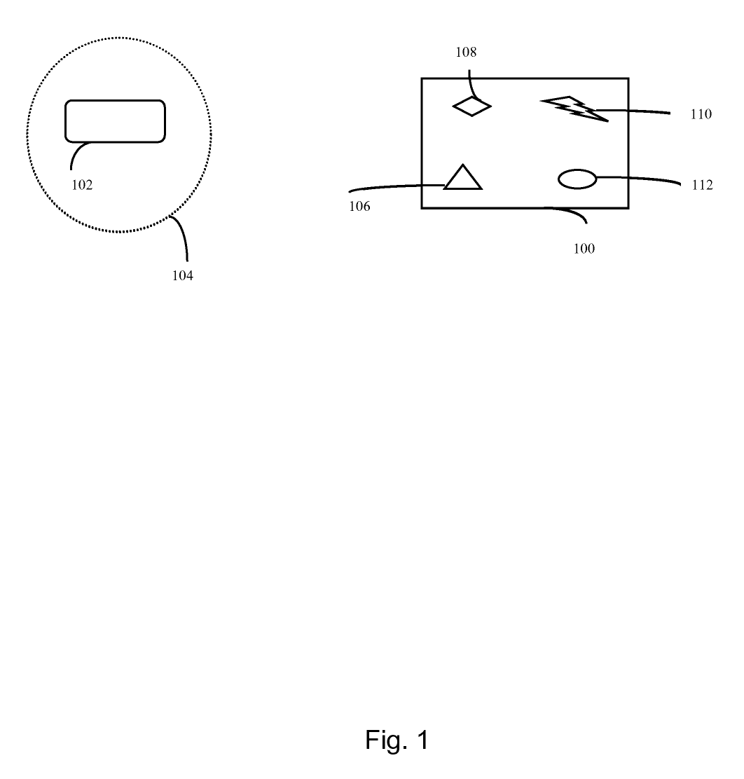

FIG. 1 illustrates a schematic representation of the system components used for determining the location of a peripheral device in accordance with an embodiment of the present invention. Referring to FIG. 1, the system 100 used for determining the location of the peripheral device 102 with an effective range 104 is illustrated. The system 100 comprises a pre-fix automatic locator application 106, a geographical positioning system 108, such as GPS to provide absolute geographical position, the dead reckoning means 110 for recording the navigation of the system to provide a geographical displacement vector, and an interface 112 to sense the connectivity of the peripheral device 102 with the system 100. As long as the system 100 is within the effective range 104 of the peripheral device 102, the device 102 remains connected with the system 100. The peripheral device 102 transmits signals that are used for establishing a physical or logical connection with the system 100.

In an embodiment of the present invention, the associated peripheral device 102 is a Bluetooth headset or otherwise similar device that is capable of emitting detectable signals such as radio waves and other short range signals, such as infrared waves used by RFID communications.

The pre-fix application 106 is designed to trap the disconnect event associated with the system 100 and the peripheral device 102. When the peripheral device 102 is connected to the system 100, the system operates as normal. When there is termination of connection between the peripheral device 102 and the system 100, the pre-fix application 106 traps the disconnect event associated with the peripheral device and marks this point of separation. The point of separation can be stored on a storage means on the system 100 or on a remotely located database or server that is coupled to the system 100. The pre-fix application 106 then immediately activates the dead reckoning means 110 which enables the immediate recording of navigational coordinates and displacement. In addition to activating the dead reckoning means 110, the pre-fix application 106 activates the GPS system 108 to enable acquisition of geographical location. GPS is a slower means and typically requires an open space with an unobstructed signal to determine, fix, or pinpoint the geographical location. When the global position is fixed by GPS 108, the pre-fix application 106 then applies the dead reckoned geographical displacement vector and global position coordinates to fix the absolute position where the termination of connection with the peripheral device 102 occurred.

In another embodiment of the present invention, the system 100 can be an iPhone, iPad, iPod, Blackberry, Droid, GPS-enabled phone (or any other smart phone or portable electronic device) with the pre-fix application, GPS, and the dead reckoning means.

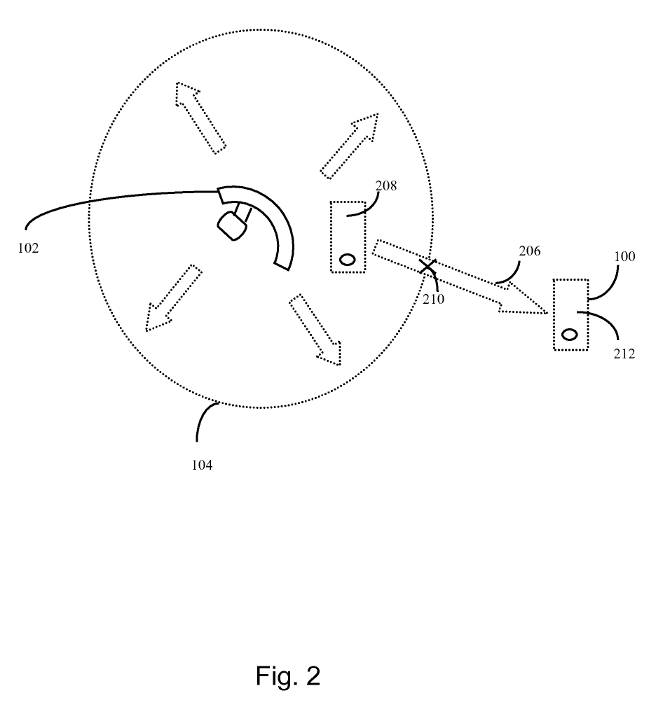

FIG. 2 illustrates the range of a peripheral device in accordance with an embodiment of the present invention. Referring to FIG. 2, a Bluetooth headset device 102 having an effective range or coverage area defined by the circumferential area 104 is illustrated. When the system 100 is within coverage area or effective range 104 of the Bluetooth headset 102, the interface 112 of the system 100 can receive the signal from the Bluetooth headset 102 and thus Bluetooth headset 102 remains connected to system 100. For instance, at position 208, the Bluetooth headset 102 is connected to the system 100. Arrow 206 indicates the movement of system 100 from position 208 to 212, wherein point 210 is the breakeven point beyond which the system 100 is extended out of the coverage area 104 of the Bluetooth headset 102. The Bluetooth headset 102 will not remain in connection with system beyond position 210. The coverage area may vary, but in an embodiment, it is between 0.1 meters to 100 meters in diameter.

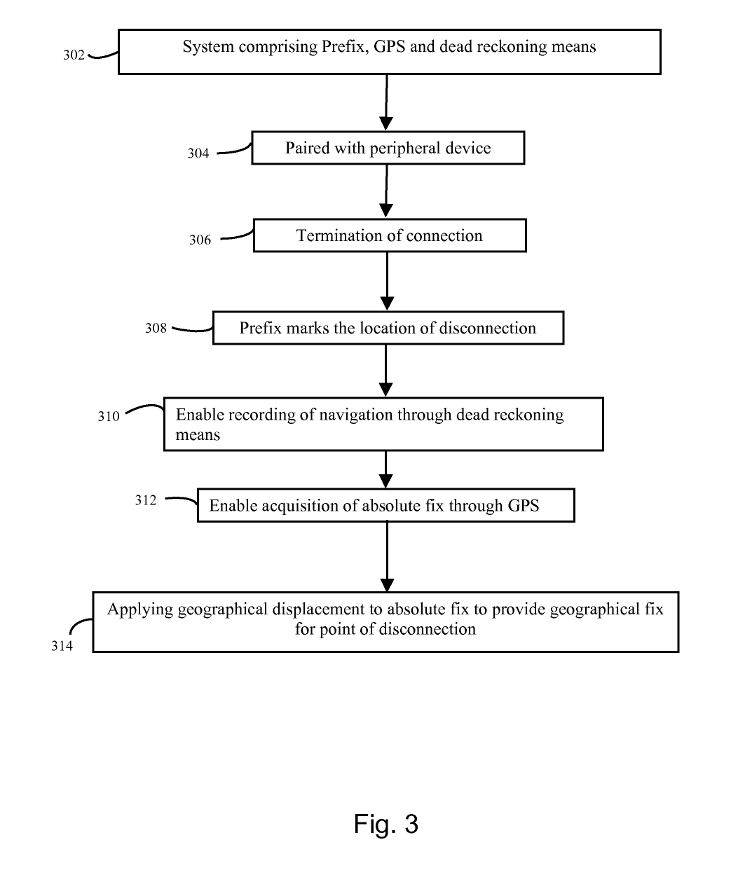

FIG. 3 is a block diagram illustrating an exemplary method for locating a peripheral device associated with the system in accordance with an embodiment of the present invention. In an embodiment, the method includes the following steps: Step 302: providing a system 100 with the pre-fix application 106, an interface 112, the geographical positioning system 108 i.e. GPS, and dead reckoning means 110; Step 304: connecting the system 100 to the peripheral device 102 that is capable of emitting detectable signals such as a Bluetooth signal or radio signals having an effective range within the circumferential area 104; Step 306: determining movement of the system 100 beyond the effective range 104 of the peripheral device 102, leading to termination of connection between the peripheral device 102 and the system 100; Step 308: The pre-fix application 106 traps the disconnect of the signal associated with the device once the system 100 moves beyond the effective range; Step 310: activating the dead reckoning means 110 to enable an and continuous immediate recording of navigation from the breakeven point of disconnect 210; Step 312: activating the GPS 108 to enable the acquisition of global position. Step 314: The pre-fix application 106 utilizes geographical displacement data provided by the dead reckoning means 110 and absolute fix obtained through GPS 108, to provide geographical position information for the point of disconnection.

In yet another embodiment of present invention, the dead reckoning means 110 includes, but is not limited, a determination of an inertial vector or magnetic rotational displacement.

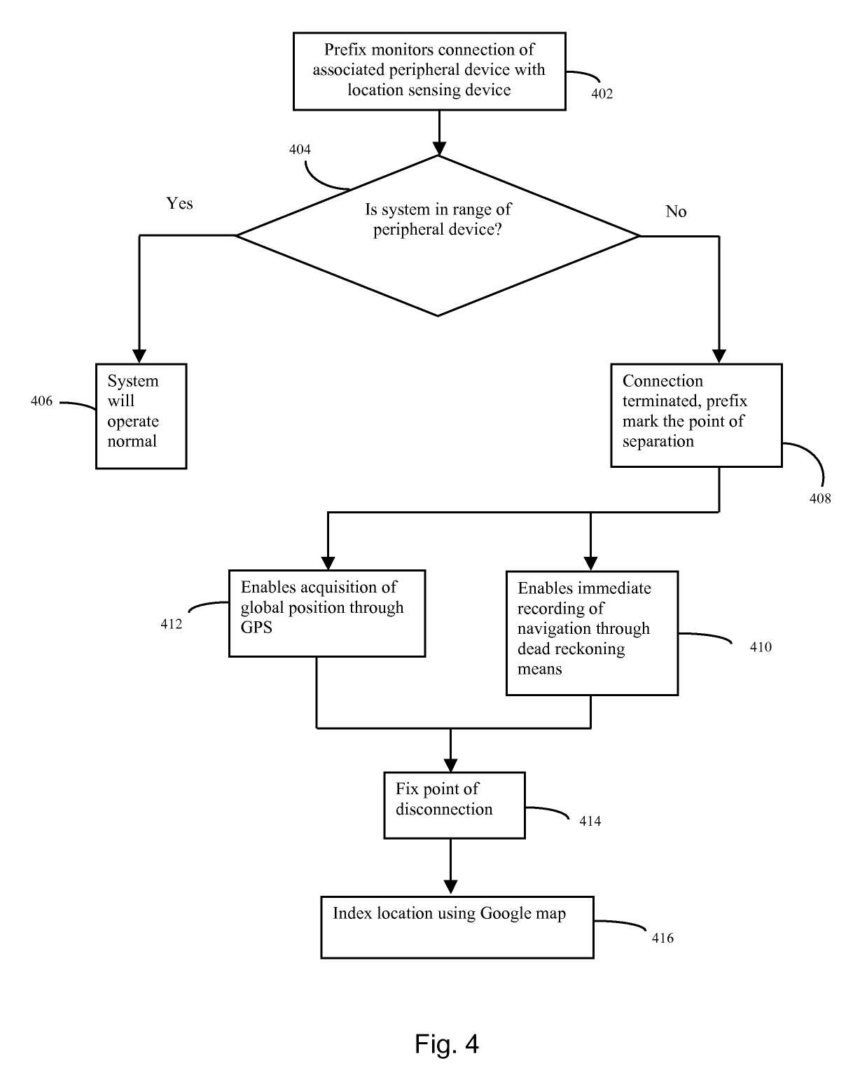

FIG. 4 illustrates a flow diagram of the search process, in accordance with an embodiment of the present invention. Referring to FIG. 4, the method followed by the system 100 is provided. Step 402 shows the system 100 consisting of pre-fix application 106, GPS 108, dead reckoning means 110, and an interface 112 to sense the signal emitted by the peripheral device 102. In step 404, the interface 112 determines whether the system 100 is in range of the peripheral device 102. If the system 100 is in range of the peripheral device 102, the system 100 operates as normal as shown in step 406. If the interface 112 does not receive signal, then the system 100 is out of range of the peripheral device 102, and termination of connection occurs. Termination of the connection activates the pre-fix application 106 as shown in step 408. The pre-fix application 106 marks the point of separation and activates the dead reckoning means 110 to enable recording of the navigation as described in step 410. Simultaneously, the pre-fix application 106 activates the geographical positioning system 108 to provide a geographical location for the point of disconnection as shown in step 412. In step 414, pre-fix application 106 applies the absolute fix made by GPS 108 and geographical displacement obtained through dead reckoning means 110 from the point of disconnection to a point where an absolute fix has been made to provide a geographical fix for the point of disconnection. Finally, the system then proceeds to index the location using the Google Maps application, or another proprietary or third-party mapping or location determining system with geographical overlays, as provided in step 416.

In yet another embodiment of present invention, the pre-fix application 106 of the system 100 applies the information from dead reckoning means 110 and the absolute position fixed by GPS 108 to locate the point of disconnection. The combined use of both of these elements is critical for providing the exact point of separation. Since GPS takes a considerable amount of time in fixing the geographical position, geographical displacement through dead reckoning means 110 is critical for fixing the accurate position of point of disconnection, as GPS may take a considerable time in fixing the geographical location. Therefore, by the time GPS fixes the global position, dead reckoning means records the geographical displacement that can then used in back-tracing the point of disconnection.

In yet another embodiment of the present invention, the system of invention can be used to find out the location of device it was peripherally coupled or attache to, and where the device was dropped, lost, or otherwise misplaced.

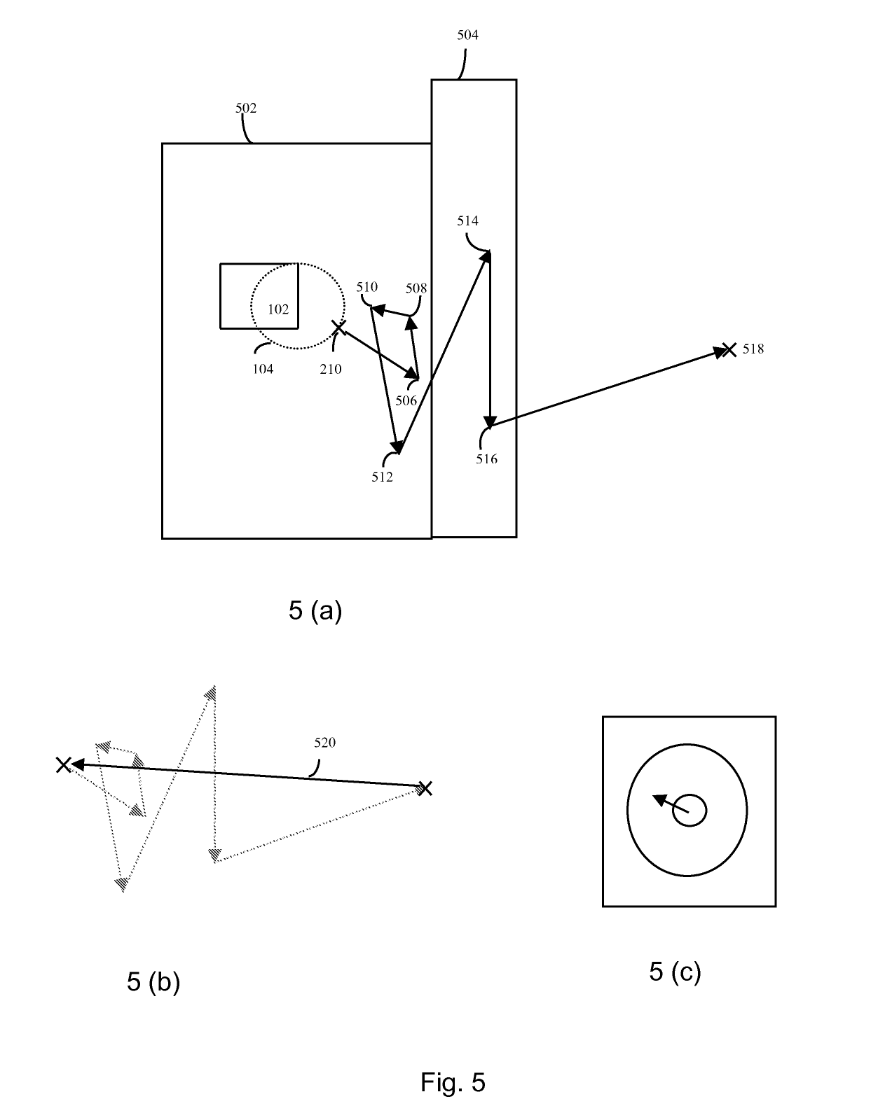

FIG. 5 illustrates an exemplary method for using the system for locating peripheral device, in accordance with an embodiment of the present invention. Referring to FIG. 5, area 502 is the user home where user has misplaced the Bluetooth headset 102 having an effective range 104. The Bluetooth headset 102 is paired with an unmodified iPhone having GPS means 108 and dead reckoning means 110. While travelling, the iPhone lost its communication link with the headset 102 at a breakeven position 210. This termination of connection activates the dead reckoning means 110, enabling recording of navigation. The arrows in FIG. 5(a) indicate the movement of a user through a defined track in area 502 to area 504 and then to the exit point of home. The user has a defined track of movement from point of disconnection 210 to point 512 in area 502 and then to point 518 while passing through the hallway 504. The pre-fix 106 activates the GPS 108 at point of disconnection 210, and the geographical coordinates are fixed at position 518 by GPS 108.

The device then resolves the actual geographical displacement occurrence from the point of disconnection 210 and the present position 518. The resolved reverse vector is shown in FIG. 5(b) where the directional vector 520 is the actual displacement taken from position 210 to position 518.

The pre-fix application 106 then applies the geographical position coordinates of position 518 and the geographical displacement vector 520 from the point of disconnection 210 to point 518, in order to provide a geographical fix for the point of disconnection 210.

In yet another embodiment of the present invention, the point of disconnection can be located within the range 104 of the associated peripheral device 102. The effective range of the peripheral device is defined as the coverage area within which the signals emitted by the device that can be detectable by the interface 112. With traditional Bluetooth headset device technology that currently exists, the range may be up to 5 meters. However, the present invention embodies a range that can extend up to 50 meters using alternative wireless communication technologies.

In yet another embodiment of present invention, the system can be used for deriving an accurate location using intelligent resolution. Once the user returns to the geographical point 518 where a geographical fix was made, the pre-fix application 106 would take the dead reckoned information and work in reverse from point 518 to provide a vector location as shown in FIG. 5(c).

In yet another embodiment of present invention, the system further facilitates the location fix without requiring an absolute fix by GPS. If a user misplaces the headset while getting dressed, for example, and travels to another room before without taking the device, the system can alert the user as to the general location within the house without needing to acquire an absolute fix. The dead reckoning data can be resolved to provide displacement vector from the point of disconnection. The system then displays the location of point of disconnection in the form of direction vector as shown in FIG. 5(c).

In another aspect of the present invention, a method of this invention provides an effective way for minimizing power consumption that is very critical for portable devices. The method achieves this by eliminating the need of maintaining a continuous fix by GPS. Since fixing GPS coordinates utilizes power, the power consumption can be very high if continuous GPS coordinates are fixed. This method avoids high power consumption by allowing the location resolution to occur only when a break in connection is encountered. Since dead reckoning information is effectively instantly available, recording this data and later using it to augment an absolute location fix eliminates the much higher power alternative of having to keep a continuous absolute fix.

In yet another embodiment of the invention, the method can be used to locate the position of a vehicle in a large parking lot. The peripheral device 102 disposed in the vehicle provides a connection with the system 100. This connection will be used to automatically locate the position of the vehicle in the parking lot. The termination of the vehicle peripheral device connection with the system will allow the pre-fix application to activate the dead reckoning means to record the displacement and enable GPS to fix the geographical position. By reaching the point where the geographical fix was made, the user is provided a more accurate location using intelligent resolution. The pre-fix application takes the dead reckoned information and works in reverse from that point to provide a vector location within the parking lot.

Various alterations and modifications in providing dedicated vehicle location are obvious to persons skilled in the art. If a vehicle does not have a built in Bluetooth or similar radio or communication means, a simple device such as one installed in a 12V car adapter (cigarette lighter) could provide a connection or link with the system. Because of the extremely high power capacity of most vehicles, an aftermarket car location adapter could also maintain a continuous geographic fix using a separate GPS and dead reckoning system or a GPS and dead reckoning system built into the vehicle. This adapter would pair with a smart phone or other such location-sensing device when the device and the vehicle are within range, just as a small peripheral. When the smart phone, car adapter, or both the smart phone and car adapter, detect that they are possibly going to be separated, such as through decreasing RF receive strength indication, the car adapter may transmit its coordinates to the system. Alternatively, because periodic Bluetooth transmission of location data would require very little power and bandwidth, the adapter could periodically transmit the current location to the location device such that the location device would contain the last location where both devices were in range. Such an approach would provide a system to have an even lower power profile since the smart phone would not need to resolve its own coordinates when the communication break took place.

In another embodiment, this invention could be used to locate luggage, pets, children, packages, mail, and other items which can be separated from a user.

What is claimed is:

1. A device to determine the location of peripheral electronic devices, comprising:
a short-range wireless connection interface;
a GPS interface coupled to a remote GPS system;
a location calculation means configured to analyze GPS coordinate information from the GPS system and local geographic displacement information; and
a memory to store local geographic displacement information.

2. The device of claim 1, wherein the short-range wireless connection interface is a Bluetooth interface.

3. The device of claim 1, wherein the location calculation means utilizes dead-reckoning to determine a location.

4. The device of claim 1, wherein the short-range wireless interface is configured to connect to a peripheral device.

5. The device of claim 4, wherein the peripheral device is a Bluetooth-enabled device.

6. The device of claim 1, wherein the short-range wireless connection interface is a radio-frequency link.

7. The device of claim 1, wherein the location calculation means is configured to calculate the location of a peripheral device.

8. A method of locating a short-range peripheral device, comprising the steps of:
connectively coupling a master device to a slave device using a wireless interface;
monitoring, using a sensor on the master device, the connection between the master device and the slave device;
recording, at the master device, a location of a disconnection between the master device and the slave device;
recording, at the master device, the navigational path of the master device after the disconnection; and
calculating, at the master device, a fixed path between an end-point of the navigational path and the location of the disconnection.

9. The method of claim 8, wherein the location of the disconnection is determined using a GPS system.

10. The method of claim 8, wherein the fixed path is calculated using dead-reckoning.

11. The method of claim 8, wherein the wireless interface is a Bluetooth interface.

12. The method of claim 8, wherein the wireless interface is a short-range wireless interface.

13. The method of claim 8, wherein the disconnection occurs at a maximum communication range between the slave device and the master device.

14. The method of claim 8, wherein the slave device is a Bluetooth-enabled peripheral.

15. The method of claim 8, wherein the slave device is coupled to a vehicle, a package, a piece of luggage, an animal, or a human being.

16. A method of locating a short-range peripheral device, comprising the steps of:
establishing a connection between a master device and a slave device, the master device coupled to a GPS system;
determining, using the GPS system, a location of termination of the connection;
transmitting, from the GPS system to the master device, the location of termination;
storing, on the master device, the location of termination;
tracking, by the GPS system, a navigational path of the master device after the termination of the connection;
transmitting, from the GPS system to the master device, the navigational path; and
computing, using the GPS system and master device, a navigational fix between the location of termination and an end-point of the navigational path.

17. The method of claim 16, wherein the navigational fix is computed using dead-reckoning.

18. The method of claim 16, wherein the master device and the slave device connected using a Bluetooth protocol.

19. The method of claim 16, wherein the location of termination is approximately equal to a boundary of the maximum connection range between the master device and the slave device.

20. The method of claim 16, wherein the master device is a phone.
